(19) United States
(12) Patent Application Publication
(10) Pub. No.: US 2025/0156336 A1
(43) Pub. Date: May 15, 2025

(54) INTERMINGLING MEMORY RESOURCES USING MULTIPLE ADDRESSING MODES

(71) Applicants: ADVANCED MICRO DEVICES, INC., Santa Clara, CA (US); ATI TECHNOLOGIES ULC, Markham (CA)

(72) Inventors: Christopher J. Brennan, Boxborough, MA (US); Mark Fowler, Boxborough, MA (US); Vydhyanathan Kalyanasundharam, Santa Clara, CA (US); Anthony Asaro, Markham (CA)

(21) Appl. No.: 18/389,021

(22) Filed: Nov. 13, 2023

(51) Int. Cl. G06F 12/1009

(52) U.S. Cl. CPC G06F 12/1009

(57) ABSTRACT

Systems and techniques enable intermingled use of disparate addressing modes for memory access requests directed to system memory resources. Within a processing system, a memory access request indicating a multi-bit physical memory address is received. Based on a bit pattern indicated by a first subset of bits of the multi-bit physical memory address, an addressing mode to be used for fulfilling the memory access request is determined, such as by selecting an addressing mode table entry that is keyed to the bit pattern. The memory access request is fulfilled in accordance with the determined addressing mode.

### BACKGROUND

To support execution of instructions, processing systems typically implement one or more compute complexes, each compute complex having one or more processor cores and a memory hierarchy having memory modules to store instructions and data to be accessed by the executing instructions. Each processor core is associated with a main memory at the top of the hierarchy that stores a larger quantity of data that can be accessed by the executing instructions at the corresponding processor core and one or more local levels of caches at lower levels of the memory hierarchy that store subsets of the data stored at the main memory. Typically, the more proximate to a processor data is stored in the memory hierarchy, the more quickly and energy-efficiently it can be accessed by the processor. To enhance processing efficiency, the processing system can implement a memory management protocol that governs the particular set of data stored at each level of the memory hierarchy.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a processing system suitable for multiple-mode addressing, in accordance with some embodiments.

FIG. 2 illustrates another view of a processing system suitable for multiple-mode addressing, in accordance with some embodiments.

FIG. 3 illustrates one potential relationship between an example system physical address and an example addressing mode table 218, in accordance with some embodiments.

FIG. 4 illustrates one example of an operational flow performed by an integrated memory controller utilizing multiple-mode addressing in accordance with some embodiments.

### DETAILED DESCRIPTION

A non-uniform memory access (NUMA) architecture generally involves a memory system that includes different regions of memory that have different access latencies and/or different bandwidths to access the regions. One example of a NUMA architecture is a graphics processing system that includes multiple central processing units (CPUs) and/or parallel processing units such as accelerator units or graphics processing units (GPUs), each of which is associated with a locally attached memory. Processing units in the system (either CPUs or GPUs) preferentially access information stored in their corresponding local memories, primarily due to lower memory access latency associated with accessing those local memories, but are not restricted to using only that local memory—they are also able to access remote memories associated with other processing units, albeit with larger memory access latencies.

Embodiments of techniques described herein enable the intermingled use of disparate addressing modes for memory access requests directed to system memory resources. For example, memory access requests directed to a single system memory resource may, in certain embodiments, be addressed by different entities (virtual machines, applications, drivers, etc.) using disparate addressing modes that are respectively associated with one or more striped (interleaved) NUMA addressing schemes (e.g., coarsely striped subdivided NUMA, device-targeted pure NUMA, etc.) or striped uniform memory access (UMA) addressing schemes (e.g., finely striped UMA), simultaneously within the same memory space. As used herein, a NUMA addressing mode is one in which each processor is designated its own local portion of system memory and can access shared memory (including other portions of system memory) across a shared bus. UMA, interleaved NUMA, and software-controlled NUMA are used interchangeably herein to denote an addressing mode in which portions of memory are interleaved across multiple banks, each associated with a particular processor or set of processors. Software-controlled NUMA refers to one or more types of NUMA memory architecture in which an operating system (OS) or other software manages memory allocation and access. Typically, such software determines which processor or processors access each bank of memory, based on factors such as thread affinity, memory usage patterns, and performance characteristics.

By enabling multiple-mode memory addressing, embodiments avoid the need for all memory resources to either exhibit uniform worst case memory latencies and bandwidth or else all entities issuing memory access requests being NUMA-aware. Instead, each requesting entity may select one resource at a time for individual optimization. For example, a system default addressing mode may be finely striped NUMA (e.g., striped NUMA with a relatively small interleave size), but for a particular memory resource could utilize a courser granularity (e.g., a larger interleave size). This allows various requesting entities (e.g., the OS, drivers, etc.) to offer multiple views into the same physical memory, where some portions of memory may be finely striped across all memory banks and channels, while other portions could be allocated one memory bank (or die) at a time. As another example, in an embodiment each of a plurality of 256 kB virtual machine (VM) memory pages is interleaved in a manner such that virtual memory control determines where to cache the memory page (e.g., across different chiplets, with varying redundancy, etc.). In such an embodiment, software-controlled NUMA may allocate an entire memory resource to a single chip or chiplet—e.g., a ring buffer for chip 0, or other preferred configuration.

In certain embodiments, the addressing mode to use may be indicated by and extracted from N bits of an physical address (PA) having a total bit length of M, with N less than M. In certain embodiments, the N most significant address bits are used to select the addressing mode for use in fulfilling a memory access request (e.g., retrieving data for fulfilling a read access request, or storing data for fulfilling a write access request). In various scenarios, these bits may be considered to be unused or ‘extra’ bits, such as if they are part of a smaller memory address space than that which the addressing scheme supports. For example, in a system in which address bit length M=41, the bit length of physical addresses supports a physical memory space of 2 TB. For a system with only 256 GB of physical memory the entire physical memory space may be addressed using only 38 bits. Therefore, the N=3 most significant bits may be utilized as an addressing mode indicator without increasing the bit length of physical addresses needed to support the actual physical memory space of the system. Continuing this example, those 3 extra bits allow for up to 2^{N}=2³=8 distinct addressing modes to be separately indicated. In other embodiments, such as those in which a greater quantity of distinct addressing modes are needed, a physical addressing scheme with greater bit length may be used.

The addressing mode used for fulfilling a memory access request may determine a variety of parameters associated with that addressing mode. As non-limiting examples, an indicated addressing mode may be associated with an addressing scheme type (e.g., NUMA, striped NUMA, software-controlled NUMA, etc.); an interleave size; one or more designated memory channels; a device and/or device type; compression and/or encryption scheme; and the like. Moreover, in certain embodiments the indicated addressing mode may include an indication of one or more bit descriptors, such as to identify a bit position of one or more access parameters (e.g., a device select bit, chip select bit, modulo or other operation identifiers, etc.) or other aspect of the addressing mode. For instance, channel bits within the physical address are dynamically adjusted in some embodiments to select larger or smaller channel interleaves, providing flexibility in optimizing memory access characteristics. Furthermore, the device or chip select bits are partitioned and reconfigured to support alternative memory access patterns in some implementations. As a non-limiting example, these bits are grouped into pairs, where each pair corresponds to a finely interleaved memory space shared by multiple devices in some cases. In this configuration, memory resources are effectively partitioned into multiple spatially distinct regions. For instance, dividing memory resources into three pairs facilitates three-way spatial partitioning among six devices, and within each partition, two devices function as if they were connected to a single UMA processor. Such dynamic bit configurations empower system software, applications, and drivers to adapt memory access strategies, optimizing performance based on specific use cases and resource availability.

Information defining one or more addressing modes is stored in one or more data structures, such as an addressing mode table (AMT) maintained for each of multiple nodes of the system in some embodiments. For example, in certain embodiments an AMT is replicated and maintained for each of multiple NUMA nodes and stored, for example, via one or more registers or register tables local to each node.

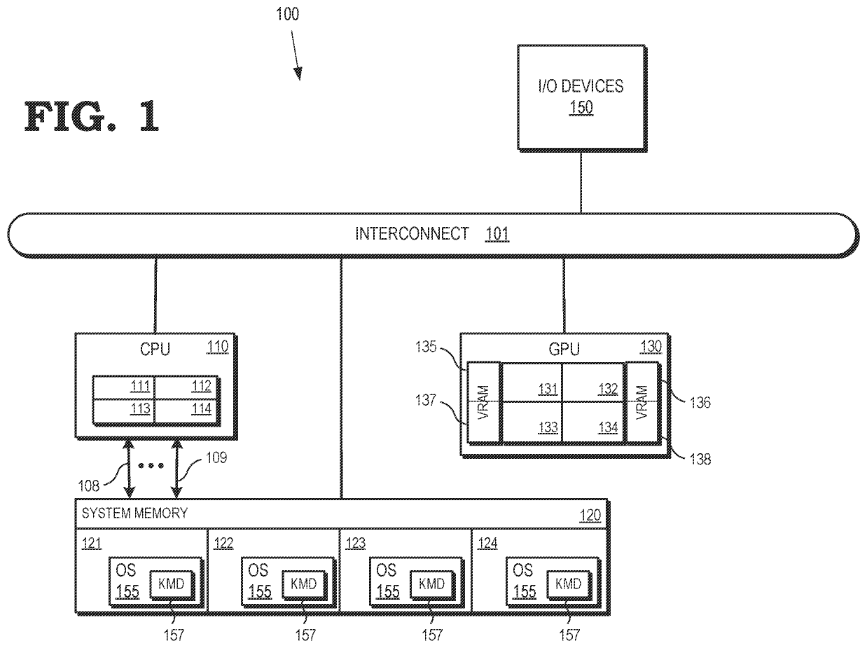

FIG. 1 illustrates a processing system suitable for multiple-mode addressing, in accordance with some embodiments. The processing system 100 can be incorporated into any of a variety of electronic devices, including a desktop computer, laptop computer, server, gaming console, smartphone, tablet, and the like. The processing system 100 is generally configured to execute instructions, organized in the form of one or more computer programs, to perform tasks on behalf of an electronic device. To facilitate execution of instructions, the processing system 100 includes a CPU 110 and a parallel processing unit such as a GPU 130. In various embodiments and scenarios, the parallel processing unit may comprise one or more tensor processors, neural processors, compute processors, or other single-instruction multiple data (SIMD) and/or single-instruction multiple-thread (SIMT) processing units.

The CPU 110 includes CPU processors 111, 112, 113, 114, each of which includes one or more instruction pipelines and associated circuitry to execute general-purpose instructions. The GPU 130 includes GPU processors 131, 132, 133, 134, each of which includes circuitry (such as one or more processing cores) to execute operations related to graphics and display functions. In some embodiments, these operations are assigned to the GPU 130 by a program (not shown) executing at the CPU 110. It will be appreciated that in some embodiments the processing system 100 can include additional CPU processors and/or GPU processors. Further, in some embodiments the processing system 100 can include other types of processing units in addition to or instead of CPUs and GPUs, such as digital signal processor (DSP) units, field programmable gate arrays (FPGAs), and the like.

In the illustrated example, the processing system 100 includes system memory banks 121, 122, 123, 124, which collectively comprise system memory 120. In discussions herein, a memory bank may refer in various contexts to a collection of circuitry comprising a contiguous plurality of memory cells, volatile or nonvolatile, and in various embodiments may comprise at least a portion of one or more integrated circuit dies (e.g., chips, chiplets, modules, etc.). System memory 120 is coupled to CPU 110 via memory channels 108, 109, which in various embodiments may comprise any number of dedicated memory channels between CPU 110 and system memory 120, each of which typically provides substantially lower latency transmission than via, inter alia, interconnect 101. Each of system memory banks 121, 122, 123, 124 is respectively coupled to CPU processors 111, 112, 113, 114, such that in various NUMA configurations and embodiments, each respective pairing of system memory bank and CPU processor forms an individual NUMA node (not specifically shown here).

In the depicted processing system 100 the GPU 130 is coupled to system memory 120 via interconnect 101. In certain embodiments the GPU 130 may be coupled to system memory 120 via one or more dedicated memory channels, in a manner similar to that discussed above with respect to memory channels 108, 109, system memory 120, and CPU 110. The GPU 130 includes video random access memory (VRAM) 135, 136, 137, 138, which may also be referred to herein as GPU local memory. As depicted, each of VRAM 135, 136, 137, 138 is respectively coupled to GPU processors 131, 133, 132, 134, such that in various NUMA configurations and embodiments, each respective pairing of VRAM and GPU processor forms an individual NUMA node (not specifically shown here).

In various embodiments, each of CPU 110 and GPU 130 include one or more cache circuitry structures (caches, not shown here) dedicated to the CPU 110 or GPU 130. Also in the depicted embodiment, the processing system 100 further includes one or more I/O devices 150, which are connected to the CPU 110 and GPU 130 via the interconnect 101. In various embodiments and scenarios, each of one or more of the I/O devices 150 may include I/O device memory that is accessible to one or both of the CPU 110 and GPU 130 via interconnect 101.

Each of system memory banks 121, 122, 123, 124 and VRAM banks 135, 136, 137, 138 includes a plurality of memory locations, with each memory location corresponding to a different physical address. The programs and operations executed at the CPU 110 and GPU 130 manipulate units of data, with each data unit corresponding to a virtual address. The range of virtual addresses employed by the CPU 110 and GPU 130 is referred to as the virtual address space of the processing system 100. As described further herein, the processing system 100 performs address translation and other operations so that the CPU 110 and GPU 130 share at least a portion of their respective virtual address spaces. The shared portion of the virtual address spaces is such that the same virtual address in each virtual address space refers to the same unit of data.

In the depicted embodiment, each of the system memory banks 121, 122, 123, 124 store at least a portion of an operating system 155, which includes a kernel mode driver (KMD) 157. In various embodiments, the KMD 157 performs a variety of functions to ensure efficient memory access and management, including one or more of memory allocation, processor thread scheduling, load-balancing between NUMA nodes, cache management, and/or memory access request routing. In various circumstances and embodiments, the system memory 120 may further store one or more additional operating system-level software components (not shown) such as device drivers, system services, operating system kernel, etc.

During operation, to access data at the system memory banks 121, 122, 123, 124 and VRAM banks 135, 136, 137, 138, the CPU 110 and GPU 130 each generate operations, referred to as memory access requests. Such memory access requests can include, for example, read requests to read data from a location and write requests to write data to a location. Each memory access request includes a virtual address indicating the location of the data to be accessed, which is to be translated to a corresponding physical address for execution at one of the system memory banks 121, 122, 123, 124 or VRAM banks 135, 136, 137, 138.

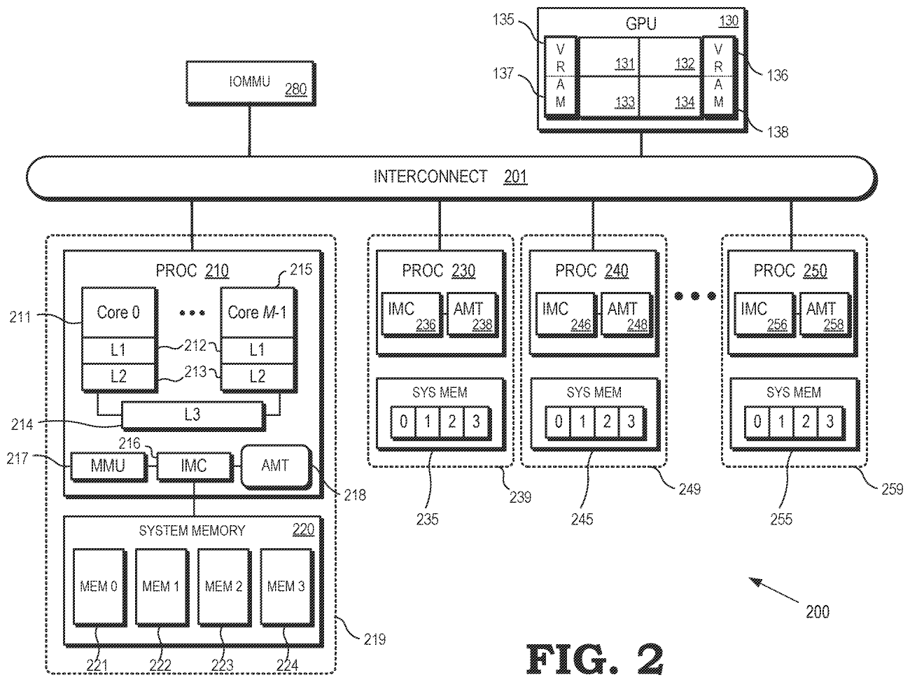

FIG. 2 illustrates a view of a processing system 200 suitable for multiple-mode addressing, in accordance with some embodiments. The processing system 200 includes an interconnect 201 that performs substantially similar operations as those described with respect to the interconnect 101 of FIG. 1. In particular, the interconnect 201 provides communicative coupling between a GPU 130 and four processors 210, 230, 240, 250.

In the depicted embodiment each of the processors 210, 230, 240, 250 is substantially identical, with greater detail and additional components illustrated and described herein with respect to processor 210 for clarity. Therefore, it will be appreciated that components described with respect to processor 210 are also included in each of processors 230, 240, and 250 unless context clearly indicates otherwise. Moreover, in various embodiments and scenarios processors 210, 230, 240, 250 may represent any quantity of processors, in a manner similar to that described above with respect to CPU 110 and GPU 130.

Processor 210 includes processing cores 211 and 215, which in various embodiments and scenarios may represent any quantity of processing cores. Each of the processing cores 211, 215 has a dedicated level I (L1) cache 212 and a dedicated level II (L2) cache 213, and access to a shared level III (L3) cache 214.

To facilitate address translation, the processor 210 includes a memory management unit (MMU) 217, which translates virtual addresses specified by memory access requests to corresponding physical addresses of locations within one or more of the system memory banks 221, 222, 223, 224 and VRAM banks 135, 136, 137, 138. The memory access request with the physical address is provided to integrated memory controller (IMC) 217 for execution at the corresponding memory bank. The IMC 217 communicates with the processor's cache hierarchy (caches 212, 213, 214) and the system memory banks 221, 222, 223, 224 to enable efficient memory access to local system memory 220, as well as to accommodate memory encryption in accordance with specified addressing modes and in various embodiments.

The processing system 200 further includes an input/output MMU (IOMMU) 280 to provide address translation for I/O device memory (not shown) of I/O devices 150 (FIG. 1), and a GPU MMU (not shown) to provide address translation for VRAM banks 135, 136, 137, 138. The IOMMU 280 translates physical addresses used by I/O devices 150 into virtual addresses that correspond to those physical memory addresses, allowing the CPU processors 210, 230, 240, 250 to enforce access control, to prevent I/O devices 150 from unauthorized access to various memory locations, and to support virtualized environments in which multiple virtual machines may be sharing physical resources provided by one or more of the I/O devices 150.

Typically, to facilitate translation of virtual addresses to physical addresses, an operating system or other program (e.g., OS 155 of FIG. 1) generates a set of memory page tables (not shown) for each of the CPU processors 210, 230, 240, 250 and GPU processors 131, 132, 133, 134. Each of the set of page tables represents a mapping of the virtual address space for the corresponding processing unit to a corresponding set of physical addresses indicating the memory locations where the corresponding data is stored by the system memory banks 221, 222, 223, 224 and VRAM banks 135, 136, 137, 138. In particular, each page table includes a plurality of entries, with each entry including a virtual address and the corresponding physical address where the data associated with the virtual address is stored.

For example, in response to the processor 210 issuing a memory access request, MMU 217 translates the virtual address indicated by the memory access request to a corresponding physical address using the page tables, for example, of the processing unit that issued the request. In particular, the MMU 217 performs a page table walk to identify an entry of the page table corresponding to the virtual address indicated by the memory access request. The identified page table entry indicates the physical address corresponding to the virtual address.

Each of processors 210, 230, 240, 250 is coupled to its local system memory bank 220, 235, 245, 255, respectively. As illustrated, the system memory 220 that is local to processor 210 includes and/or is partitioned into four distinct memory banks 221, 222, 223, 224. In a similar manner, each of system memory 235, 245, 255 includes and/or is partitioned into four distinct memory banks (but for purposes of clarity, not separately identified herein). It will be appreciated that in various embodiments and scenarios, the system memory 220 may be partitioned into various partitioning configurations, including those with greater or fewer quantities of partitions than those referenced in any particular example herein. For purposes of NUMA addressing modes, processor 210 and system memory 220 form a NUMA node 219; processor 230 and system memory 235 form a NUMA node 239; processor 240 and system memory 245 form a NUMA node 249; and processor 250 and system memory 255 form a NUMA node 259.

In a similar manner, and as described above with respect to processing system 100 of FIG. 1, each of VRAM 135, 136, 137, 138 is respectively coupled to GPU processors 131, 133, 132, 134, such that for purposes of NUMA addressing modes, each respective pairing of VRAM and GPU processor (respectively, 131 and 135; 132 and 136; 133 and 137; and 134 and 138) forms an individual NUMA node (not separately identified).

In the depicted embodiment, and as analogously discussed elsewhere herein, information defining one or more addressing modes is stored in an addressing mode table (AMT) 218, which is maintained for each of multiple nodes of the system as shown via AMT 238 of processor 230, AMT 248 of processor 240, and AMT 258 of processor 250. Each AMT 218, 238, 248, 258 is respectively coupled to an integrated memory controller (IMC) 217, 236, 246, 256. In certain embodiments at least one AMT is stored via one or more registers or register tables local to each NUMA and/or processing node.

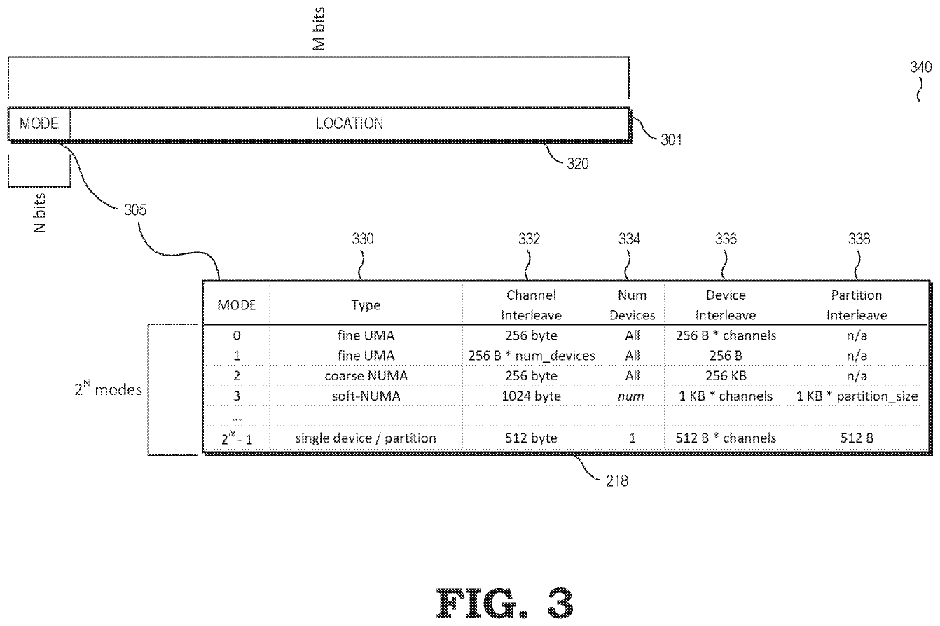

FIG. 3 depicts one potential relationship between a physical memory address 301 and an example addressing mode table 218, in accordance with some embodiments. As described elsewhere herein, the physical memory address 301 may be generated as the result of a page table walk by MMU 217 (FIG. 2), by which it identifies the physical memory address 301 as corresponding to a virtual address (not shown) that is specified by a memory access request from processor 210.

In the depicted embodiment and scenario, the physical memory address 301 has a bit length of M bits. Partitioned within those M bits, the physical memory address 301 includes an addressing mode identifier 305 and local address (location) 320. While in other embodiments the mode identifier 305 may be located elsewhere within the physical memory address 301, in the depicted embodiment the mode identifier 305 occupies the most significant N bits, and the bit length of location 320 is M-N bits.

The mode identifier 305 is utilized as a unique key within the AMT 218, which includes up to 2^{N}−1 entries that each define a distinct addressing mode. In the depicted embodiment, the AMT 218 includes multiple parameters associated with each entry: an addressing scheme type 330 (specifying the type of memory addressing scheme employed by the indicated mode), channel interleaving parameter 332 (indicating a degree of interleaving applied across memory channels or banks, and thereby how memory access requests are distributed and managed across channels), num_devices parameter 334 (identifying the device or devices to which the indicated mode applies), device interleaving parameter 336 (defining the interleaving pattern at the device or module level), and partition interleaving parameter 338 (defining how memory resources are partitioned and interleaved at the partition level).

As one illustrative example, mode identifier 305 identifies a first mode 0 with indicated parameters specifying a finely-striped UMA addressing scheme with a relatively fine-grained 256-byte channel interleaving size, with device-level interleaving based on the number of memory channels. All available memory devices are addressable using this indicated mode. These parameters generally describe a memory addressing mode for finely interleaved devices in which data is distributed across memory channels at a granular level of 256 bytes, making use of all available devices without partitioning.

Additional addressing modes are defined within the AMT 218 in a manner similar to that described above with respect to addressing mode 0.

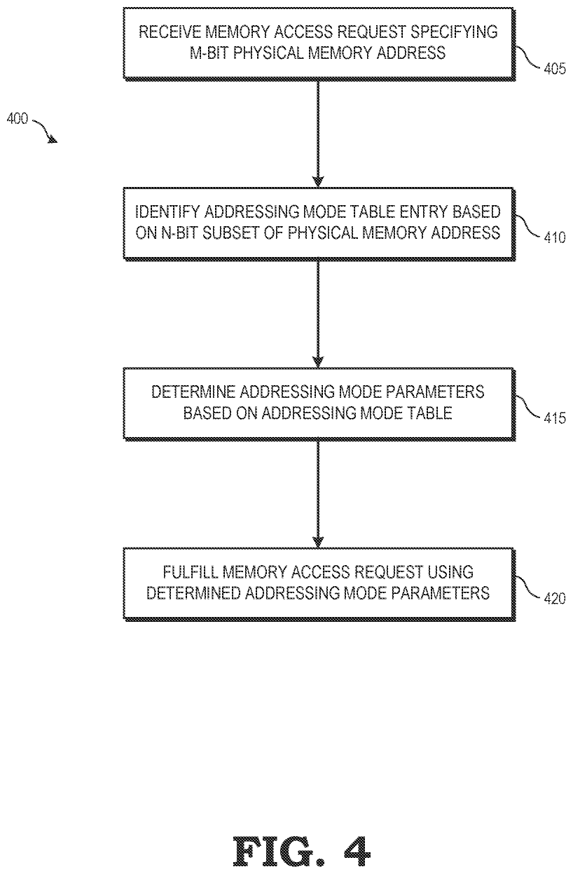

FIG. 4 illustrates one example of an operational flow routine 400 performed, for example, by an integrated memory controller (e.g., IMC 216 of FIG. 2) of a processing system (e.g., processing system 100 of FIG. 1 or processing system 200 of FIG. 2) in accordance with some embodiments.

The routine 400 begins at block 405, in which the IMC receives a memory access request specifying a physical memory address (e.g., physical memory address 301 of FIG. 3) having a bit length of M bits. As noted elsewhere herein, in various embodiments the memory access request may be received from a memory management unit (MMU) following a translation from a virtual address originally identified by the memory access request. The routine proceeds to block 410.

At block 410, the IMC identifies a unique entry of a local addressing mode table (e.g., AMT 218 of FIGS. 2 and 3) based on a bit pattern indicated by a first subset of bits in the physical memory address, such as if the addressing mode table includes a mode identifier corresponding to the indicated bit pattern. The routine proceeds to block 415.

At block 415, the IMC determines a set of addressing mode parameters based on the identified unique entry from the local addressing mode table. As described elsewhere herein, such addressing mode parameters may include, as non-limiting examples: an addressing scheme type, interleave size, designated memory channel(s); a device and/or device type; compression and/or encryption parameters; etc. Upon determining the set of addressing mode parameters to use for fulfilling the memory access request, the routine proceeds to block 420, in which the IMC fulfills the memory access requests using the determined set of addressing mode parameters.

In some embodiments, the apparatus and techniques described above are implemented in a system including one or more integrated circuit (IC) devices (also referred to as integrated circuit packages or microchips), such as the processing systems described above with reference to FIGS. 1-4. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

One or more of the elements described above is circuitry designed and configured to perform the corresponding operations described above. Such circuitry, in at least some implementations, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some implementations, the circuitry for a particular element is selected, arranged, and configured by one or more computer-implemented design tools. For example, in some implementations the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry”, etc.) are described or claimed as “configured” to perform one or more tasks or operations. This formulation—[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving within a processor a memory access request indicating a multi-bit physical memory address; and
fulfilling the memory access request in accordance with an addressing mode based on a bit pattern indicated by a first subset of bits of the multi-bit physical memory address.

2. The method of claim 1, wherein the addressing mode comprises a type of interleaving to use for fulfilling the memory access request.

3. The method of claim 1, further comprising:
determining a type of non-uniform memory access (NUMA) addressing associated with the addressing mode to use for fulfilling the memory access request.

4. The method of claim 1, further comprising:
identifying a memory channel to use for fulfilling the memory access request.

5. The method of claim 1, further comprising:
determining a memory encryption scheme to use for decoding the memory access request.

6. The method of claim 1, further comprising:
determining the addressing mode based on an entry associated with the indicated bit pattern in an addressing mode table (AMT).

7. The method of claim 6, wherein the indicated bit pattern comprises N bits, and wherein the AMT comprises up to 2^{N} distinct addressing modes.

8. The method of claim 6, wherein the multi-bit physical memory address has a bit length of M bits, wherein the N bits are the most significant bits of the multi-bit physical memory address, and wherein a physical memory space of the processor comprises a quantity of address locations that is addressable by no more than M-N bits.

9. The method of claim 1, wherein receiving the memory access request includes receiving a virtual memory address corresponding to the multi-bit physical memory address, and wherein the method further comprises translating the virtual memory address to generate the multi-bit physical memory address.

10. A processing system comprising a memory controller, the memory controller to:
receive a memory access request indicating a multi-bit physical memory address; and
fulfill the memory access request in accordance with an addressing mode based on a bit pattern indicated by a first subset of bits of the multi-bit physical memory address.

11. The processing system of claim 10, wherein the addressing mode comprises one or more of a type of interleaving or an interleave size to use for fulfilling the memory access request.

12. The processing system of claim 10, wherein the memory controller is to determine a type of non-uniform memory access (NUMA) addressing associated with the addressing mode to use to fulfill the memory access request.

13. The processing system of claim 10, wherein the addressing mode comprises a memory channel to use to fulfill the memory access request.

14. The processing system of claim 10, wherein the addressing mode comprises a memory encryption scheme to use to fulfill the memory access request.

15. The processing system of claim 10, wherein the memory controller is to determine the addressing mode based on an entry associated with the indicated bit pattern in an addressing mode table (AMT).

16. The processing system of claim 15, wherein the indicated bit pattern comprises N bits, and wherein the AMT comprises up to 2^{N} distinct addressing modes.

17. The processing system of claim 15, wherein the multi-bit physical memory address has a bit length of M bits, wherein the N bits are the most significant bits of the multi-bit physical memory address, and wherein a physical memory space of the processing system comprises a quantity of address locations that is addressable by no more than M-N bits.

18. The processing system of claim 10, further comprising a memory management unit to translate a virtual memory address in order to generate the multi-bit physical memory address.

19. A memory controller, the memory controller to:
receive a memory access request indicating a multi-bit physical memory address; and
fulfill the memory access request in accordance with an addressing mode based on a bit pattern indicated by a first subset of bits of the multi-bit physical memory address.

20. The memory controller of claim 19, wherein the addressing mode comprises one or more of a type of interleaving or an interleave size to use for fulfilling the memory access request.
